(19) United States
(12) Patent Application Publication
(10) Pub. No.: US 2024/0169372 A1
(43) Pub. Date: May 23, 2024

(54) SERVER DEVICE, PRESENTATION METHOD, AND NON-TRANSITORY COMPUTER READABLE MEDIA FOR PRESENTING CANDIDATE LISTS

(71) Applicant: RAKUTEN MOBILE, INC., Tokyo (JP)

(72) Inventor: Ko KIKUCHI, Tokyo (JP)

(73) Assignee: RAKUTEN MOBILE, INC., Tokyo (JP)

(21) Appl. No.: 17/786,140

(22) PCT Filed: Mar. 11, 2022
(86) PCT No.: PCT/JP2022/010974

§ 371 Date: Sep. 14, 2023

(51) Int. Cl. G06Q 30/0201; G06Q 30/0241

(52) U.S. Cl. CPC G06Q 30/0201; G06Q 30/0241

(57) ABSTRACT

A searcher (141) searches a purchased commodity purchased on an electronic market by a viewer who viewed motion video delivered from a deliverer, in association with each of a plurality of the deliverers to which a request for advertisement of a target commodity is capable of being made. A selector (142) selects a representative commodity from the purchased commodities searched by the searcher (141), in association with each of the deliverers. In addition, a presenter (143) presents a candidate list, in which the representative commodity selected by the selector (142) is correlated with each of the deliverers, to an advertiser terminal.

### TECHNICAL FIELD

The present disclosure relates to a server device, a presentation method, and non-transitory computer readable media for presenting candidate lists.

### BACKGROUND ART

In recent years, attention has been paid to e-commerce called “live commerce”. The live commerce is e-commerce in such a form that a deliverer delivers live video that introduces a commodity and a viewer viewing the live video can purchase the commodity.

For example, Patent Literature 1 discloses a system that can support introduction of a commodity using motion video. In this system, before delivery, a deliverer can freely select, from a plurality of commodities, a commodity (introduced commodity) that is introduced by delivered motion video. Specifically, if any one of commodities is selected by the deliverer, a request for approval of advertisement (introduction) by the deliverer is made to an advertiser of the selected commodity. Here, if the approval by the advertiser is obtained, the deliverer is enabled to introduce the commodity by the delivery by the deliverer himself/herself. In the actually performed live delivery (real-time motion video delivery), the deliverer introduces the commodity with enthusiasm, and viewers, who agreed, purchase the commodity, and thereby remuneration corresponding to the number of purchased commodities (sales performance) is paid to the deliverer.

### CITATION LIST

### Patent Literature

Patent Literature 1: Unexamined Japanese Patent Application Publication No. 2018-26152

### SUMMARY OF INVENTION

### Technical Problem

In the system disclosed in Patent Literature 1, since the scheme is adopted in which, with the selection of the commodity by the deliverer as a trigger, the request for approval is made to the advertiser of the commodity, the advertiser who is the receiver side cannot freely select the deliverer. Thus, a request is not always made from an appropriate deliverer for introducing the advertiser's commodity, and it is difficult for the advertiser to make a request for advertisement to the appropriate deliverer. In addition, a similar problem arises when making a request for advertisement of a commodity to a sender who sends information through various contents, aside from the deliverer who delivers such motion video.

The present disclosure has been made in order to solve the above problem, and an objective of the disclosure is to provide a server device, a presentation method, and non-transitory computer readable media, which can support an advertiser in making a request for advertisement to a more appropriate sender.

### Solution to Problem

A server device according to a first aspect of the present disclosure includes a processor to execute:
search of a purchased commodity purchased on an electronic market by a user who received information sent from a sender, in association with each of a plurality of the senders to which a request for advertisement of a target commodity is capable of being made;
selection of a representative commodity from the searched purchased commodities in association with each of the senders; and
presentation of a candidate list, in which the selected representative commodity is correlated with each of the senders, to an advertiser terminal.

In the server device according to the above aspect,
the sender may be a deliverer who delivers motion video, and
the user may be a viewer who viewed the motion video delivered from the deliverer.

In the server device according to the above aspect,
the selection of the representative commodity may be executed based on at least any one of a time of purchase of the purchased commodities, a total number of the purchased commodities, and a degree of correlation between the purchased commodities and the target commodity.

In the server device according to the above aspect,
the selected representative commodities may include a first representative commodity selected from the purchased commodities with a high degree of correlation with the target commodity, and a second representative commodity selected from the purchased commodities with a low degree of correlation with the target commodity.

In the server device according to the above aspect,
the processer may further execute narrow-down of the senders, the narrow-down being based on at least any one of a popularity of the sender, an advertisement fee for making a request to the sender, and a degree of correlation between a sending content of the sender and the target commodity.

In the server device according to the above aspect,
the processer may further execute evaluation of an influence of the sender, and
in the presented candidate list, the senders sorted in accordance with the evaluated influence may be correlated with the representative commodities.

In the server device according to the above aspect,
the processor may further execute:
acceptance of a sender to whom a request is made, the sender being selected in the advertiser terminal to which the candidate list is presented; and
making a request for the advertisement of the target commodity to the accepted sender.

A presentation method according to a second aspect of the present disclosure causes a computer to execute:
search of a purchased commodity purchased on an electronic market by a user who received information sent from a sender, in association with each of a plurality of the senders to which a request for advertisement of a target commodity is capable of being made;
selection of a representative commodity from the searched purchased commodities in association with each of the senders; and
presentation of a candidate list, in which the selected representative commodity is correlated with each of the senders, to an advertiser terminal.

Non-transitory computer readable media according to a third aspect of the present disclosure record a program for causing a computer to execute:
search of a purchased commodity purchased on an electronic market by a user who received information sent from a sender, in association with each of a plurality of the senders to which a request for advertisement of a target commodity is capable of being made;
selection of a representative commodity from the searched purchased commodities in association with each of the senders; and
presentation of a candidate list, in which the selected representative commodity is correlated with each of the senders, to an advertiser terminal.

### Advantageous Effects of Invention

According to the present disclosure, an advertiser can be supported in making a request for advertisement to a more appropriate sender.

### BRIEF DESCRIPTION OF DRAWINGS

FIG. 1 is a schematic view illustrating an example of an entire configuration of a delivery system according to Embodiment 1 of the present disclosure;

FIG. 2 is a block diagram illustrating an example of a schematic configuration of a typical information processing apparatus by which a support server or the like is implemented;

FIG. 3 is a block diagram illustrating an example of a functional configuration of a support server according to Embodiment 1;

FIG. 4 is a schematic view illustrating an example of deliverer management information;

FIG. 5 is a schematic view illustrating an example of viewer management information;

FIG. 6 is a schematic view illustrating an example of purchase history information;

FIG. 7 is a schematic view illustrating an example of aggregate information;

FIG. 8 is a schematic view illustrating an example of a candidate list;

FIG. 9 is a schematic view illustrating another example of the candidate list;

FIG. 10 is a block diagram illustrating an example of a functional configuration of a delivery server;

FIG. 11 is a block diagram illustrating an example of a functional configuration of an advertiser terminal;

FIG. 12 is a block diagram illustrating an example of a functional configuration of a deliverer terminal;

FIG. 13 is a flowchart for describing a presentation process according to Embodiment 1;

FIG. 14 is a schematic view illustrating an example of an entire configuration of a delivery system according to Embodiment 2 of the present disclosure;

FIG. 15 is a block diagram illustrating an example of a functional configuration of a support server according to Embodiment 2;

FIG. 16 is a schematic view illustrating an example of a candidate list; and

FIG. 17 is a flowchart for describing a presentation process according to Embodiment 2.

### DESCRIPTION OF EMBODIMENTS

Hereinafter, embodiments of the present disclosure are described in detail with reference to the accompanying drawings. In the drawings, identical or equivalent parts are denoted by identical reference signs. In addition, hereinafter, although a description is given of a support server (server device) that is suitable when an advertiser makes a request for advertisement (introduction) of a commodity to a deliverer of motion video, the deliverer is an example of a sender, and the present disclosure can similarly be applied to a case of making a request for advertisement to a sender that sends information through other contents (for example, a blog, a social networking service (SNS), and the like). Besides, it is assumed that the term “commodity” (a target commodity or the like), which is described below, includes not only a physical commodity, but also an electronic commodity (for example, electronic money, software such as games sold by download, a right of use of the software, electronic items, and the like). Specifically, embodiments described below are intended for descriptions, and do not restrict the scope of the present disclosure. Thus, a person skilled in the art can adopt embodiments in which individual elements or all elements of the embodiments below are replaced with equivalent elements, and these embodiments are also included in the scope of the present disclosure.

### Embodiment 1

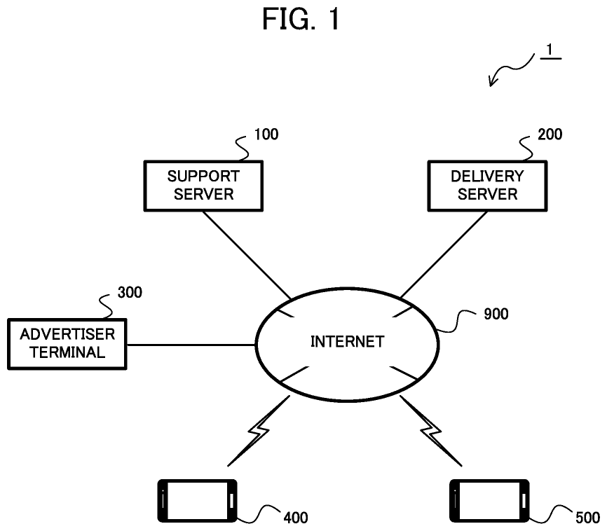

FIG. 1 is a schematic view illustrating an example of an entire configuration of a delivery system 1 according to Embodiment 1 of the present disclosure. In the delivery system 1, for example, a support server 100 that supports an advertiser, a delivery server 200 that manages delivery, an advertiser terminal 300 used by the advertiser, a deliverer terminal 400 used by a deliverer, and a viewer terminal 500 used by a viewer are communicably connected via an Internet 900. Note that it is assumed that many advertiser terminals 300, deliverer terminals 400 and viewer terminals 500 are present in accordance with the number of advertisers, deliverers and viewers, who use the system.

The support server 100 is, for example, a server device (a computer for a server, or the like), presents a candidate list of deliverers (a candidate list CL1 or the like to be described later) to the advertiser terminal 300, and supports an advertiser in making a request for advertisement to a more appropriate deliverer. In other words, the support server 100 generates a candidate list (details are described later) including useful information in order for the advertiser to easily select a deliverer to which a request for introduction (advertisement) of a target commodity is made, and presents the candidate list to the advertiser terminal 300. In addition, the support server 100 requests the deliverer, who is selected by the advertiser from the presented candidate list, to deliver motion video for introducing a target commodity. Note that the support server 100 can exchange information with a predetermined sales server (not illustrated), and stores purchase history information to be described later (information relating to commodities purchased by viewers on a predetermined electronic market).

The delivery server 200 is, for example, a server device, and manages delivery (for example, live streaming, or streaming of recorded motion video) performed by a deliverer. Specifically, the delivery server 200 receives video (motion video that introduces commodities) sent from the deliverer terminal 400, and delivers the video to the viewer terminal 500.

The advertiser terminal 300 is, for example, a terminal such as a personal computer (PC), a smartphone or a tablet, and is used by an advertiser of a commodity (target commodity) that is a target of advertisement. In a concrete example, the advertiser terminal 300 displays the candidate list that is sent from the support server 100. The advertiser selects a deliverer to whom a request for introduction of a target commodity is made, with reference to, as a criterion, representative commodities (details are described later) correlated with the deliverers, included in the candidate list.

The deliverer terminal 400 is, for example, a terminal such as a smartphone, a tablet or a PC, and is used by a deliverer who performs delivery (for example, live streaming). In a concrete example, the deliverer delivers motion video that introduces a target commodity requested by the advertiser.

The viewer terminal 500 is, for example, a terminal such as a smartphone, a tablet or a PC, and is used by a viewer who views the motion video delivered by the deliverer. In a concrete example, the viewer operates the viewer terminal 500 and executes login, or the like, to the delivery server 200, and thereafter views the live video delivered from the deliverer terminal 400 via the delivery server 200.

(Schematic Configuration of Information Processing Apparatus 600)

A description is given of a typical information processing apparatus 600 by which the support server 100, delivery server 200, advertiser terminal 300, deliverer terminal 400 and the like according to Embodiment 1 are implemented.

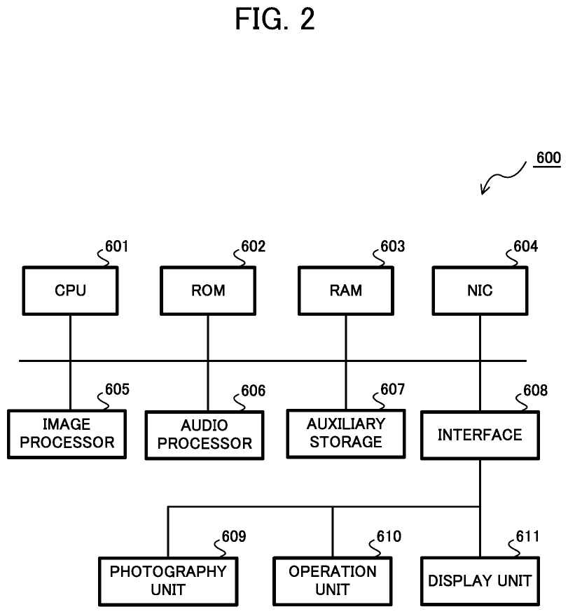

As illustrated in FIG. 2, the information processing apparatus 600 includes a central processing unit (CPU) 601, a read-only memory (ROM) 602, a random access memory (RAM) 603, a network interface card (NIC) 604, an image processor 605, an audio processor 606, an auxiliary storage 607, an interface 608, a photography unit 609, an operation unit 610, and a display unit 611.

The CPU 601 controls an operation of the entirety of the information processing apparatus 600, is connected to the respective structural components, and exchanges control signals and data with structural components.

An initial program loader (IPL) that is executed immediately after power-on is recorded in the ROM 602, and, by the execution of the IPL, a program stored in the auxiliary storage 607 is loaded in the RAM 603, and the execution of the program by the CPU 601 is started.

The RAM 603 is configured to temporarily store data and programs, and stores programs and data read from the auxiliary storage 607, and other data necessary for communication, and the like.

The NIC 604 is configured to connect the information processing apparatus 600 to a computer communication network such as the Internet, and is constituted by a component supporting 10BASE-T/100BASE-T standards used in constructing a local area network (LAN), an analog modem for connection to the Internet using a telephone line, an integrated services digital network (ISDN) modem, an asymmetric digital subscriber line (ADSL) modem, a cable modem for connection to the Internet using a cable television line, or the like.

The image processor 605 processes image data that is read from the auxiliary storage 607 or the like, by the CPU 601 or an image arithmetic processor (not illustrated) included in the image processor 605, and then records the processed image data in a frame memory (not illustrated) included in the image processor 605. The image information recorded in the frame memory is converted to a video signal at a predetermined synchronization timing, and is output to the display unit 611 via the interface 608 or the like. In other words, under the control of the CPU 601, the image processor 605 generates an image that is necessary in the progress of the process executed by the information processing apparatus 600, and causes the display unit 611 to display the image.

The audio processor 606 converts music data or audio data, which is read from the auxiliary storage 607 or the like, to an audio signal, and outputs the audio signal to the outside via the interface 608 or the like. Note that when the information processing apparatus 600 includes a speaker in the inside thereof, the audio processor 606 outputs the converted audio signal to the speaker. In other words, under the control of the CPU 601, the audio processor 606 generates music sound or audio, which is to be generated in the progress of the process executed by the information processing apparatus 600, and causes an internal or external speaker to output the music sound or the like.

The auxiliary storage 607 is a hard disk, a solid state drive (SSD), or the like, and stores various programs and various data necessary for the operational control of the entirety of the information processing apparatus 600. For example, a program for implementing the support server 100 or the like according to the embodiment is stored in the auxiliary storage 607. In addition, by the control of the CPU 601, the auxiliary storage 607 reads out the stored program or data as appropriate, and causes the RAM 603 or the like to temporarily store the program or data.

The interface 608 supports, for example, standards such as HDMI (trademark), a universal serial bus (USB) and an inter-integrated circuit (I2C), and the photography unit 609, operation unit 610 and display unit 611 are connected to the interface 608. Note that the interface 608 may transmit and receive necessary information to and from other connected external equipment.

The photography unit 609 is, for example, a fixed focal lens, an imaging element with a predetermined number of pixels (a complementary metal oxide semiconductor (CMOS) or a charge coupled device (CCD)), or the like, and captures a still image or motion video.

The operation unit 610 accepts an operation input of a worker or the like, who utilizes the information processing apparatus 600.

The display unit 611 renders an image corresponding to the image data that is output from the image processor 605, and presents the image to the worker or the like, who utilizes the information processing apparatus 600.

Besides, the information processing apparatus 600 may include, in place of the auxiliary storage 607, a drive unit of a digital versatile disc (DVD)-ROM or the like. In this case, the information processing apparatus 600 reads programs and data from the DVD-ROM or the like loaded in the drive unit, and operates in the same manner as described above.

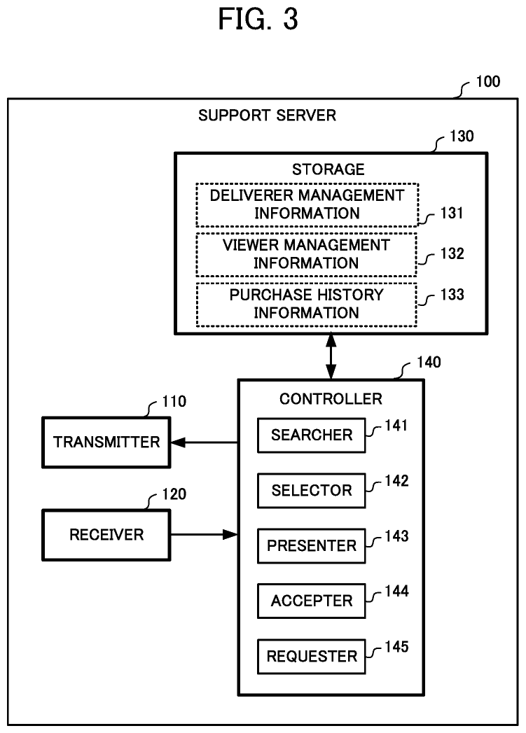

Hereinafter, referring to FIG. 3 to FIG. 12, a description is given of functions or the like of the support server 100, delivery server 200, advertiser terminal 300 and deliverer terminal 400, which are implemented in the above-described information processing apparatus 600. Upon power-on of the information processing apparatus 600, programs that enable the functions as the support server 100, delivery server 200, advertiser terminal 300 and deliverer terminal 400 according to Embodiment 1 are executed, and the support server 100, delivery server 200, advertiser terminal 300 and deliverer terminal 400 according to Embodiment 1 are implemented. Although the viewer terminal 500 is similarly implemented by the information processing apparatus 600, the viewer terminal 500 includes substantially the same configuration as the deliverer terminal 400, and therefore a description thereof is omitted.

(Functional Configuration of Support Server 100)

FIG. 3 is a block diagram illustrating an example of a functional configuration of the support server 100 according to Embodiment 1. As illustrated, the support server 100 includes a transmitter 110, a receiver 120, a storage 130, and a controller 140.

The transmitter 110 transmits via the Internet 900 various information directed to the advertiser terminal 300, deliverer terminal 400 and the like. For example, the transmitter 110 is controlled by the controller 140 (presenter 143 to be described later), and transmits to the advertiser terminal 300 a candidate list (candidate list CL1 or the like to be described later) for enabling the advertiser to easily select the deliverer. In addition, the transmitter 110 is controlled by the controller 140 (requester 145 to be described later), and transmits, when a deliverer is selected from the candidate list presented to the advertiser terminal 300, request information for requesting introduction of a target commodity to the deliverer terminal 400 of the selected deliverer. Note that the above-described NIC 604 can function as the transmitter 110.

The receiver 120 receives various information that is sent from the advertiser terminal 300 or the like via the Internet 900. For example, the receiver 120 receives identification information (deliverer ID or the like) of the selected deliverer, which is returned from the advertiser terminal 300 when the deliverer is selected from the candidate list presented to the advertiser terminal 300. Note that the above-described NIC 604 can function as the receiver 120.

The storage 130 stores various information necessary for the processing in the support server 100. For example, the storage 130 stores deliverer management information 131, viewer management information 132, and purchase history information 133.

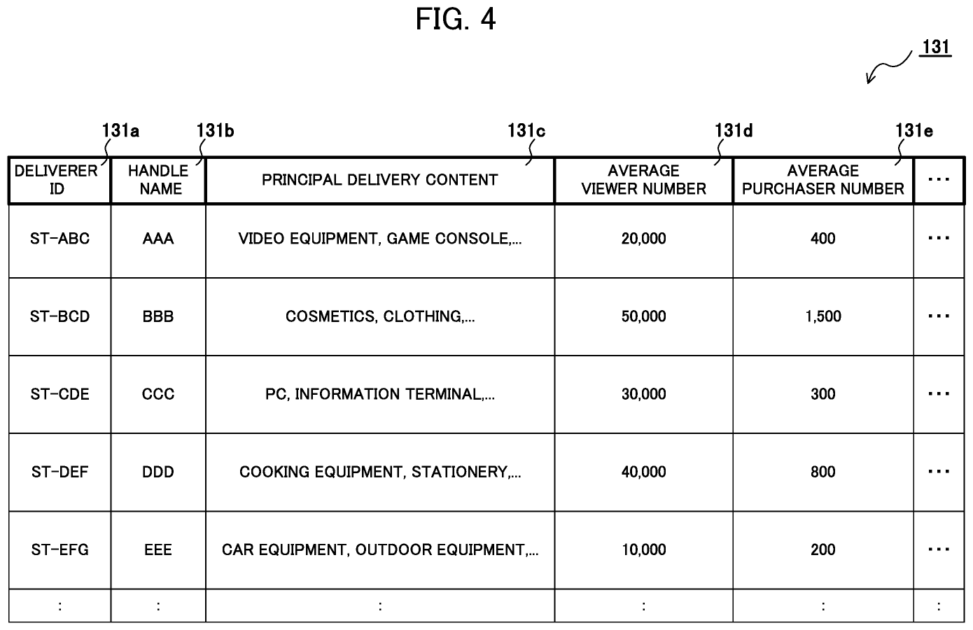

The deliverer management information 131 is information that manages deliverers who use the deliverer terminals 400, and includes information as illustrated in FIG. 4 as an example. Specifically, the deliverer management information 131 includes information such as a deliverer ID 131a, a handle name 131b, a principal delivery content 131c, an average viewer number 131d, an average purchaser number 131e, and the like. Note that the principal delivery content 131c indicates genres of commodities introduced in the motion video of the deliverer within a predetermined most recent period (for example, within one year from the present). The average viewer number 131d indicates an average number of viewers who have viewed the motion video delivered by the deliverer within the predetermined period. In addition, the average purchaser number 131e indicates an average number of purchasers (purchasers among viewers) who have purchased commodities introduced in the motion video delivered by the deliverer within the predetermined period.

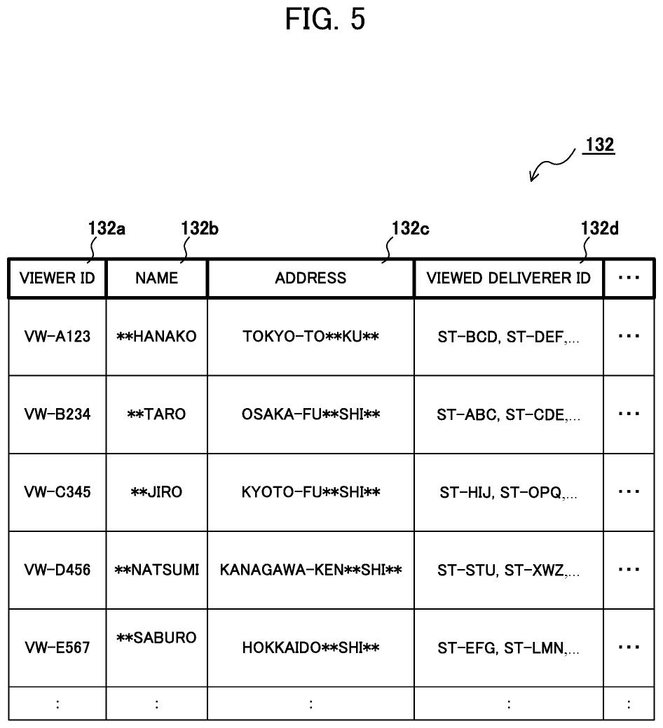

Referring back to FIG. 3, the viewer management information 132 is information that manages viewers who use the viewer terminals 500, and includes information as illustrated in FIG. 5 as an example. Specifically, the viewer management information 132 includes a viewer ID 132a, a name 132b, an address 132c, a viewed deliverer ID 132d, and the like. Note that the viewed deliverer ID 132d indicates identification information of deliverers who deliver the motion video viewed by the viewer within a predetermined most recent period (for example, within one year from the present).

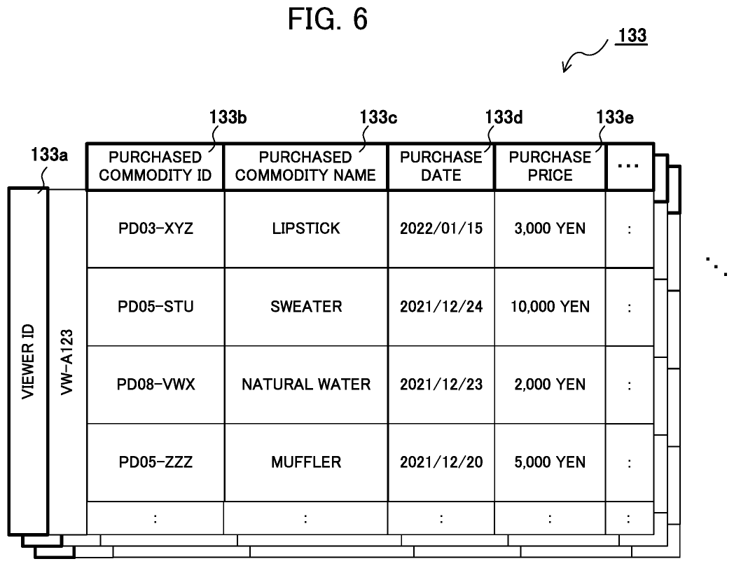

Referring back to FIG. 3, the purchase history information 133 is information about commodities (including commodities purchased regardless of the viewing of motion video) purchased by the viewer on a predetermined electronic market within a predetermined most recent period (for example, within one year from the present), and includes information as illustrated in FIG. 6 as an example. Specifically, the purchase history information 133 includes a viewer ID 133a, a purchased commodity ID 133b, a purchased commodity name 133c, a purchase date 133d, a purchase price 133e, and the like. Note that although the purchased commodity name 133c is expressed by a simplified description, the purchased commodity name 133c is, in fact, expressed by a detailed commodity name that can identify the commodity.

The storage 130 stores other various information necessary for the processing of the controller 140. For example, the storage 130 also stores information relating to an advertiser, including a commodity (target commodity) of the advertiser. Note that the above-described auxiliary storage 607 can function as the storage 130.

Referring back to FIG. 3, the controller 140 controls the entirety of the support server 100. The controller 140 includes, for example, a searcher 141, a selector 142, a presenter 143, an accepter 144, and a requester 145.

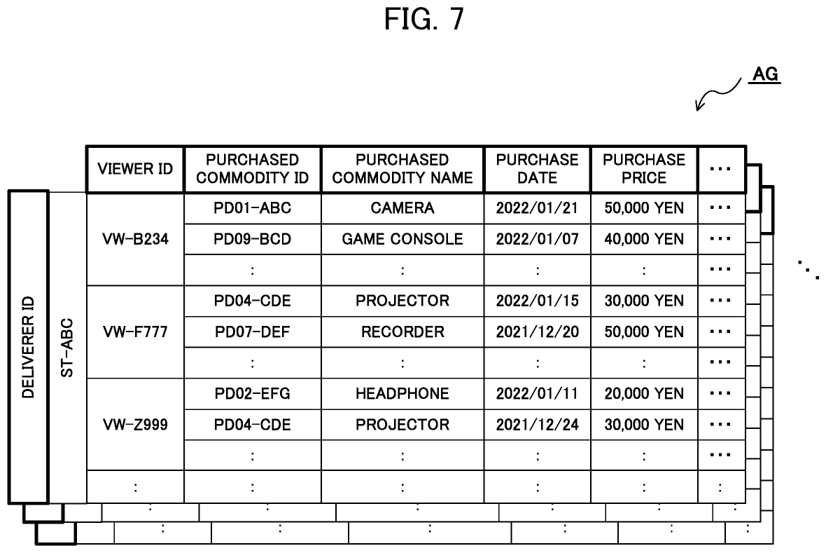

The searcher 141 searches, in association with each of a plurality of deliverers to which a request for advertisement of a target commodity can be made, a purchased commodity purchased on the electronic market by a viewer who has viewed the motion video delivered by the deliverer. For example, the searcher 141 searches the above-described purchase history information 133 illustrated in FIG. 6, and generates aggregate information AG as illustrated in FIG. 7. In the aggregate information AG, purchased commodities of viewers corresponding to each deliverer are aggregated. Note that the correspondence relation between deliverers and viewers is specified based on the viewer IDs 132a and viewed deliverer IDs 132d in the viewer management information 132 illustrated in FIG. 5 described above.

Referring back to FIG. 3, the selector 142 selects, in association with each of the deliverers, a representative commodity from among the purchased commodities searched by the searcher 141. For example, when the above-described aggregate information AG illustrated in FIG. 7 is searched and a representative commodity of the deliverer (deliverer ID: “ST-ABC”) is selected, the selector 142 selects one representative commodity from among the purchased commodities (camera, game console, projector, recorder, headphone, projector, . . . ) of viewers (viewer IDs: “VW-B234”, “VW-F777”, “VW-Z999”, . . . ). Note that the selection of the representative commodity is executed, for example, based on at least one of the time of purchase of purchased commodities, the total number of purchased commodities, and the degree of correlation between purchased commodities and a target commodity. For example, when the selection of the representative commodity is based on the total number of purchased commodities, the selector 142 selects, as the representative commodity, a commodity (for example, a projector) that is the largest in the number of purchases, among the purchased commodities of the respective viewers.

Note that the selector 142 may be configured to select a plurality of representative commodities in association with each deliverer. For example, the selector 142 selects a first representative commodity from purchased commodities with a high degree of correlation with the target commodity, and selects a second representative commodity from purchased commodities with a low degree of correlation with the target commodity. Specifically, the selector 142 classifies purchased commodities of each viewer into commodities with a high degree of correlation and commodities with a low degree of correlation, with reference to the target commodity of the advertiser, and selects representative commodities from both. Note that the degree of correlation, for example, is converted to numerical values in advance among the categories of commodities, and, if the degree of correlation between the category of the target commodity and the category of a purchased commodity is a threshold or more, the purchased commodity is classified as a commodity with the high degree of correlation, and, if the degree of correlation between the category of the target commodity and the category of a purchased commodity is less than the threshold, the purchased commodity is classified as a commodity with the low degree of correlation.

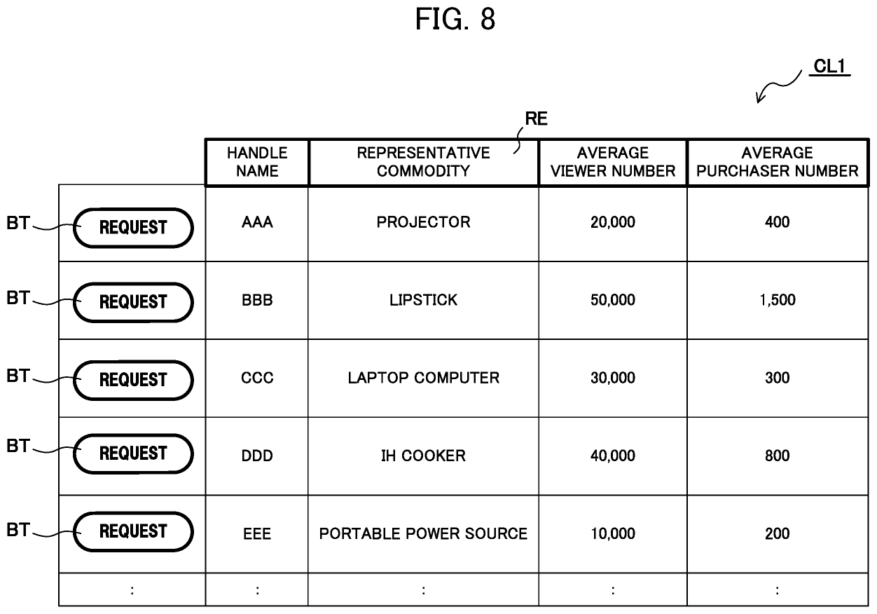

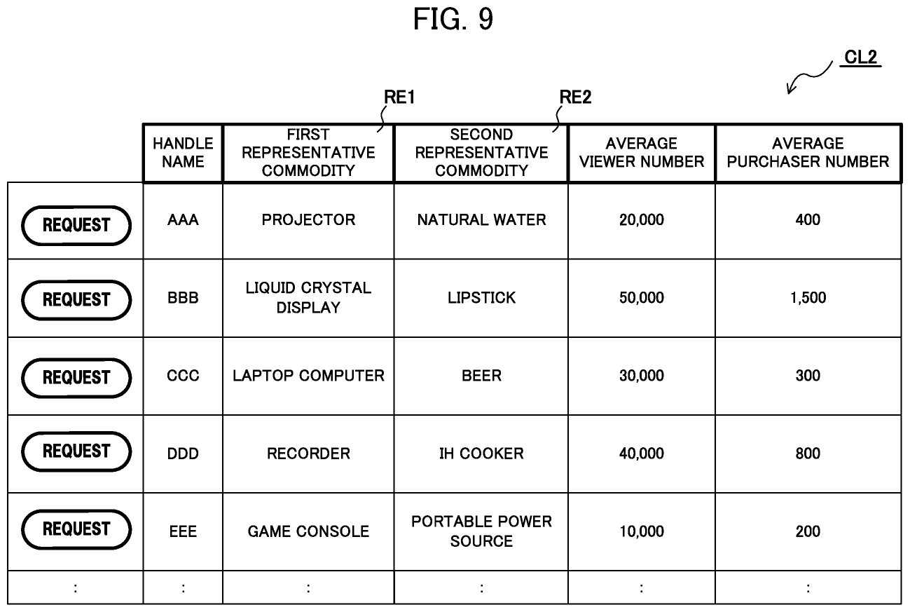

The presenter 143 generates a candidate list in which the representative commodities selected by the selector 142 are correlated with deliverers, and presents the generated candidate list to the advertiser terminal 300. For example, the presenter 143 generates a candidate list CL1 as illustrated in FIG. 8, and presents the candidate list CL1 to the advertiser terminal 300. In the candidate list CL1, representative commodities RE selected by the selector 142 are correlated with the deliverers (handle names). In addition, the candidate list CL1 includes select buttons BT for the advertiser to select the deliverer. Note that when two representative commodities are selected by the selector 142 in association with each deliverer, the presenter 143 generates, for example, a candidate list CL2 as illustrated in FIG. 9, and presents the candidate list CL2 to the advertiser terminal 300. In the candidate list CL2, a first representative commodity RE1 with a high degree of correlation with the target commodity and a second representative commodity RE2 with a low degree of correlation with the target commodity are associated with the deliverers.

Referring back to FIG. 3, the accepter 144 accepts the deliverer selected by the advertiser in the advertiser terminal 300 to which the candidate list is presented. For example, if any one of the select buttons BT in the above-described candidate list CL1 illustrated in FIG. 8 is pressed by the advertiser, the identification information (deliverer ID or the like) of the deliverer corresponding to the pressed select button BT is returned to the support server 100 from the advertiser terminal 300. Thus, the accepter 144 accepts the identification information of the deliverer via the receiver 120.

The requester 145 requests the deliverer of the identification information, which is accepted by the accepter 144, to introduce the target commodity. Specifically, the requester 145 transmits request information requesting the introduction of the target commodity to the deliverer terminal 400 of the deliverer indicated by the identification information. The details of the target commodity, the content of remuneration, and the like can be viewed from the deliverer terminal 400 that received the request information. Note that the request information may be transmitted to the deliverer terminal 400 by an email, an SNS, or the like. Besides, the requester 145 may simply present to the advertiser terminal 300 a contact address, such an email address or an SNS account, of the deliverer of the identification information accepted by the accepter 144.

The above-described CPU 601 or the like can function as the controller 140 of this configuration.

(Functional Configuration of Delivery Server 200)

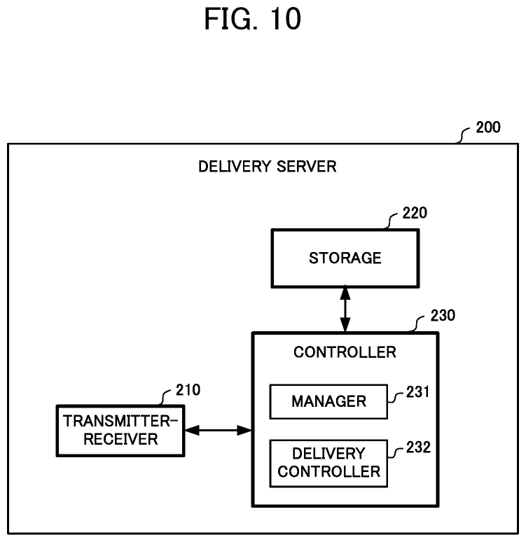

FIG. 10 is a block diagram illustrating an example of a functional configuration of the delivery server 200. As illustrated, the delivery server 200 includes a transmitter-receiver 210, a storage 220, and a controller 230.

The transmitter-receiver 210 transmits and receives various information to and from the support server 100, deliverer terminal 400 and viewer terminal 500 via the Internet 900. For example, the transmitter-receiver 210 receives the candidate list that is sent from the support server 100. In addition, the transmitter-receiver 210 receives video (for example, live video) that is sent from the deliverer terminal 400, and delivers the received video to the viewer terminal 500. Note that the above-described NIC 604 can function as the transmitter-receiver 210.

The storage 220 stores various necessary information for the processing in the delivery server 200. For example, the storage 220 stores the ID, password and the like of the viewer that uses the viewer terminal 500. Note that the above-described auxiliary storage 607 or the like can function as the storage 220.

The controller 230 controls the entirety of the delivery server 200. The controller 230 includes, for example, a manager 231 and a delivery controller 232.

The manager 231, for example, collates the ID, password and the like, which are sent from the viewer terminal 500 that requests login, with the ID, password and the like stored in the storage 220, and authenticates the viewer.

The delivery controller 232 controls the transmitter-receiver 210, and delivers the video received from the deliverer terminal 400 to the viewer terminal 500.

The above-described CPU 601 or the like can function as the controller 230 of this configuration.

(Functional Configuration of Advertiser Terminal 300)

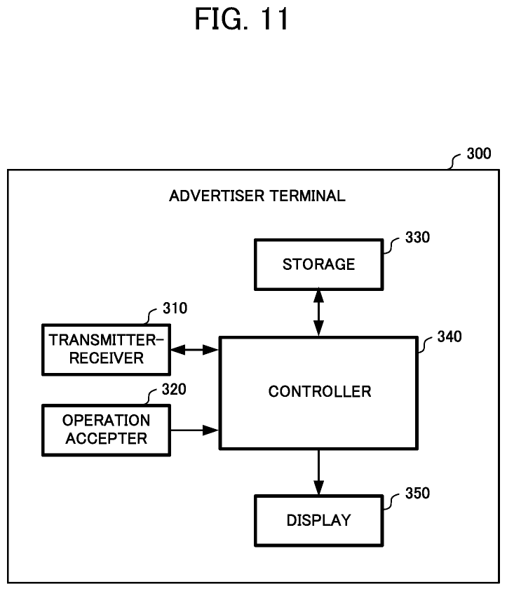

FIG. 11 is a block diagram illustrating an example of a functional configuration of the advertiser terminal 300. As illustrated, the advertiser terminal 300 includes a transmitter-receiver 310, an operation accepter 320, a storage 330, a controller 340, and a display 350.

The transmitter-receiver 310 transmits and receives various information to and from the support server 100 via the Internet 900. For example, the transmitter-receiver 310 receives the candidate list that is sent from the support server 100. Note that the above-described MC 604 can function as the transmitter-receiver 310.

The operation accepter 320 is a pointing device (a mouse or the like) or a touch panel, and accepts various operations from the advertiser. For example, the operation accepter 320 accepts selection of the deliverer in the candidate list displayed on the display 350. Note that the above-described operation unit 610 can function as the operation acceptor 320.

The storage 330 stores various necessary information for the processing in the advertiser terminal 300. For example, the storage 330 stores detailed information or the like of the target commodity. Note that the above-described auxiliary storage 607 or the like can function as the storage 330.

The controller 340 controls the entirety of the advertiser terminal 300. For example, the controller 340 causes the display 350 to display the candidate list received by the transmitter-receiver 310. In addition, when the operation acceptor 320 accepts the selection of the deliverer in the candidate list, the controller 340 controls the transmitter-receiver 310 and returns the identification information of the selected deliverer to the support server 100. Note that the above-described CPU 601 or the like can function as the controller 340.

The display 350 displays the candidate list received by the transmitter-receiver 310. Specifically, the display 350 displays the above-described candidate list CL1, CL2, as illustrated in FIG. 8 and FIG. 9. Note that the above-described display unit 611 can function as the display 350.

(Functional Configuration of Deliverer Terminal 400)

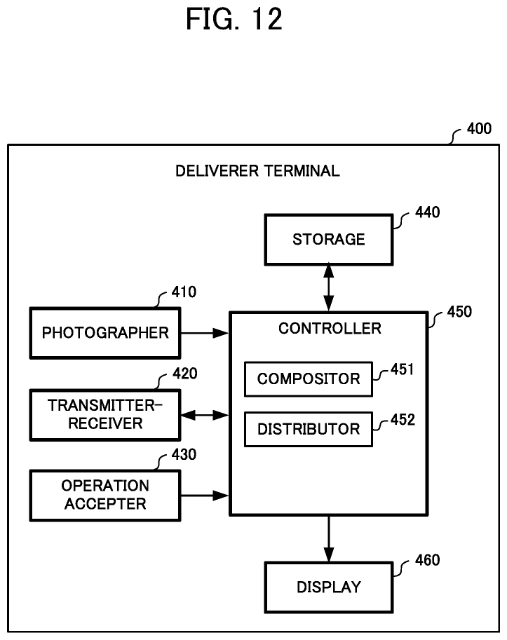

FIG. 12 is a block diagram illustrating an example of a functional configuration of the deliverer terminal 400. As illustrated, the deliverer terminal 400 includes a photographer 410, a transmitter-receiver 420, an operation accepter 430, a storage 440, a controller 450, and a display 460.

The photographer 410 is, for example, a camera disposed in the deliverer terminal 400, and photographs the deliverer or the like during delivery. Specifically, the photographer 410 outputs, during delivery, video (for example, live video) including the deliverer. Note that the above-described photography unit 609 can function as the photographer 410.

The transmitter-receiver 420 transmits and receives various information to and from the delivery server 200 via the Internet 900. For example, the transmitter-receiver 420 is controlled by the controller 450 (distributor 452 to be described later), and transmits the video captured by the photographer 410 to the delivery server 200 (delivers the video to the viewer terminal 500 via the delivery server 200). Besides, the transmitter-receiver 420 receives request information that is sent from the support server 100. Note that the above-described NIC 604 can function as the transmitter-receiver 420.

The operation accepter 430 is a touch panel or a pointing device, and accepts various operations from the deliverer. For example, the operation accepter 430 accepts an operation directed to an object that is composited on the video captured by the photographer 410. Note that the above-described operation unit 610 can function as the operation acceptor 430.

The storage 440 stores various necessary information for the processing in the deliverer terminal 400. For example, the storage 440 stores information relating to an object for compositing on the captured video, a position of compositing of the object, and the like. For example, the object is subtitles (banner) including text information for notification to the viewer in the live streaming. In addition, the position of compositing is a position of compositing the object in the video. Note that the above-described auxiliary storage 607 or the like can function as the storage 440.

The controller 450 controls the entirety of the deliverer terminal 400. The controller 450 includes, for example, a compositor 451 and a distributor 452.

The compositor 451 composites an object in video captured by the photographer 410. For example, the compositor 451 composites, in the captured video, text information for notification to the viewer, in accordance with the information of the object stored in the storage 440, and the position of compositing.

The distributor 452 transmits the video, in which the object is composited by the compositor 451, to the delivery server 200 for delivery to the viewer terminal 500. Specifically, the distributor 452 controls the transmitter-receiver 420, transmits the video, in which the object is composited, to the delivery server 200, and delivers the video to the viewer terminal 500 via the delivery server 200.

Note that the above-described CPU 601 or the like can function as the controller 450 of this configuration.

The display 460 displays the video in which the object is composited by the above-described compositor 451. Note that the above-described display unit 611 can function as the display 460.

(Operation of Support Server 100)

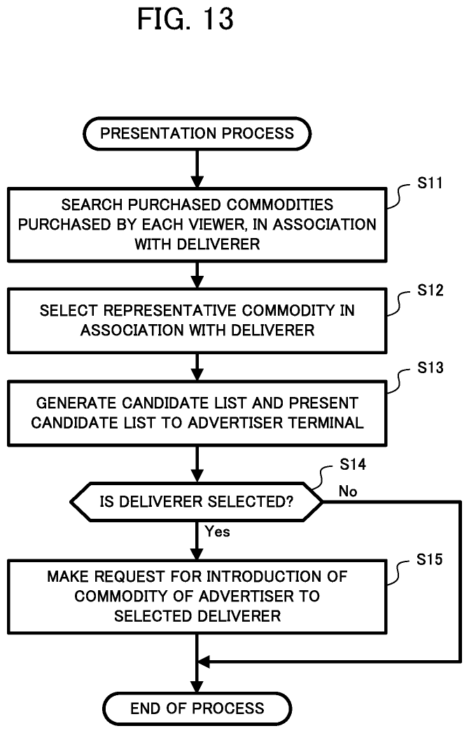

Hereinafter, an operation of the support server 100 is described with reference to FIG. 13. FIG. 13 is a flowchart for describing a presentation process according to Embodiment 1. The presentation process is executed by the support server 100, for example, when information of a target commodity that is a target of advertisement is sent from the advertiser terminal 300 to the support server 100.

To start with, the support server 100 searches purchased commodities purchased by each viewer, in association with deliverers (step S11). For example, the controller 140 (searcher 141) searches the purchase history information 133 as illustrated in FIG. 6, and generates the aggregate information AG as illustrated in FIG. 7. In the aggregate information AG, the purchased commodities of viewers, which are associated with each deliverer, are aggregated.

The support server 100 selects a representative commodity in association with the deliverer (step S12). Specifically, the controller 140 (selector 142) selects the representative commodity from the purchased commodities searched in the above-described step S11. For example, one representative commodity is selected from the purchased commodities of the aggregate information AG as illustrated in FIG. 7. Note that the selection of the representative commodity is executed, for example, based on at least one of the time of purchase of purchased commodities, the total number of purchased commodities, and the degree of correlation between purchased commodities and the target commodity. For example, when the selection of the representative commodity is based on the total number of purchased commodities, the controller 140 selects, as the representative commodity, a commodity that is the largest in the number of purchases, among the purchased commodities of the respective viewers.

Note that, in step S12, the controller 140 may be configured to select a plurality of representative commodities in association with the deliverer. For example, the controller 140 selects a first representative commodity from purchased commodities with a high degree of correlation with the target commodity, and selects a second representative commodity from purchased commodities with a low degree of correlation with the target commodity. Specifically, the controller 140 classifies purchased commodities of each viewer into commodities with a high degree of correlation and commodities with a low degree of correlation, with reference to the target commodity of the advertiser, and selects representative commodities from both.

The support server 100 generates a candidate list and presents the candidate list to the advertiser terminal 300 (step S13). In other words, the controller 140 (presenter 143) generates a candidate list in which the representative commodities selected in step S12 are correlated with the deliverers, and presents the generated candidate list to the advertiser terminal 300. For example, the controller 140 generates the candidate list CL1 as illustrated in FIG. 8, and presents the candidate list CL1 to the advertiser terminal 300. In the candidate list CL1, the representative commodities RE selected in step S12 are correlated with the deliverers. In addition, the candidate list CL1 includes the select buttons BT for the advertiser to select the deliverer (handle name) that the advertiser requests to introduce the target commodity. Note that, in step S12, when two representative commodities are selected in association with each deliverer, the controller 140 generates the candidate list CL2 as illustrated in FIG. 9, and presents the candidate list CL2 to the advertiser terminal 300. In the candidate list CL2, the first representative commodity RE1 with a high degree of correlation with the target commodity and the second representative commodity RE2 with a low degree of correlation with the target commodity are associated with the deliverers.

The support server 100 determines whether the deliverer is selected (step S14). For example, the controller 140 determines whether any one of the select buttons BT is pressed in the advertiser terminal 300 to which the candidate list CL1 illustrated in FIG. 8 is presented. Note that if any one of the select buttons BT in the candidate list CL1 is pressed by the advertiser, the identification information (deliverer ID or the like) of the deliverer corresponding to the pressed select button BT is returned to the support server 100 from the advertiser terminal 300.

If the support server 100 determines that the deliverer is selected (step S14; Yes), the support server 100 requests the selected deliverer to introduce the commodity of the advertiser (step S15). In other words, the controller 140 (requester 145) requests the deliverer of the identification information, which is returned from the advertiser terminal 300, to introduce the target commodity. Specifically, request information requesting the introduction of the target commodity is transmitted to the deliverer terminal 400 of the deliverer indicated by the identification information. The details of the target commodity, the content of remuneration, and the like can be viewed from the deliverer terminal 400 that received the request information. Note that the request information may be transmitted to the deliverer terminal 400 by an email, an SNS, or the like.

On the other hand, when no selection of the deliverer is determined (step S14; No), the support server 100 ends the presentation process. Note that the determination of no selection of the deliverer is made, for example, when the candidate list CL1 is closed without pressing of the select button BT.

By this presentation process, the candidate list CL1, CL2, as illustrated in FIG. 8 and FIG. 9, is presented to the advertiser terminal 300. Since the candidate list CL1, CL2 includes the representative commodities RE (first representative commodities RE1, second representative commodities RE2), it becomes easier to determine a deliverer whose viewers match with the purchaser base for the target commodity of the advertiser, and the advertiser can select an appropriate deliverer. Note that if the advertiser is simply enabled to freely select a deliverer without considering the viewers of the deliverer, it is considered that the advertiser selects a deliverer, for example, based on only name recognition or popularity. However, viewers who view the motion video of a deliverer selected based on only name recognition or popularity do not always match with the purchaser base for actual purchase of the commodity of the advertiser, and there is concern that a sufficient advertisement effect cannot be obtained. On the other hand, in the present disclosure, since actual commodity examples purchased by viewers are presented, the advertiser can select the deliverer who is to be requested, with agreement in an easy-to-understand manner. As a result, a support can be provided for the advertiser to make a request for advertisement to a more appropriate deliverer.

### Embodiment 2

In Embodiment 1 described above, the case was described in which the candidate list including all deliverers, to which requests can be made, is presented to the advertiser terminal 300, but deliverers, who are clearly excluded from the candidates in view of the relation with the target commodity, may be excluded from the candidate list. In addition, a candidate list, in which deliverers are sorted as appropriate, may be presented to the advertiser terminal 300. Hereinafter, a description is given of a delivery system having a feature that a candidate list, in which deliverers are narrowed down and deliverers are sorted, is presented to the advertiser terminal 300.

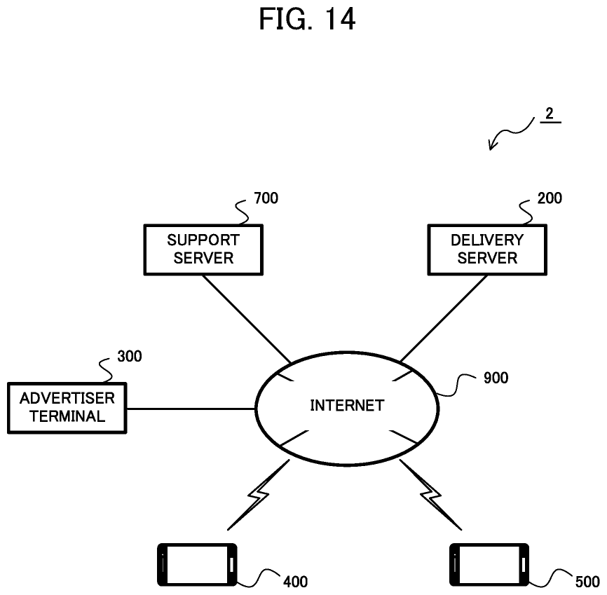

FIG. 14 is a schematic view illustrating an example of an entire configuration of a delivery system 2 according to Embodiment 2 of the present disclosure. In the delivery system 2, for example, a support server 700 that supports an advertiser, a delivery server 200 that manages delivery, an advertiser terminal 300 used by the advertiser, a deliverer terminal 400 used by a deliverer, and a viewer terminal 500 used by a viewer are communicably connected via an Internet 900. Note that the delivery server 200, advertiser terminal 300, deliverer terminal 400 and viewer terminal 500 have the same configurations as in the delivery system 1 according to Embodiment 1 described above. In other words, only the support server 700 is different from the delivery system 1 of FIG. 1.

The support server 700, too, is implemented by the above-described information processing apparatus 600 of FIG. 2. Specifically, if the information processing apparatus 600 is powered on, a program enabling a function as the support server 700 according to Embodiment 2 is executed, and the support server 700 according to Embodiment 2 is implemented.

(Functional Configuration of Support Server 700)

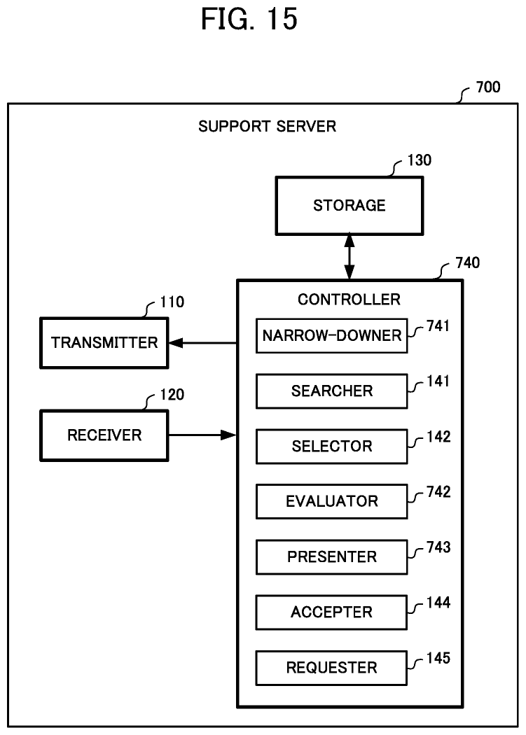

FIG. 15 is a block diagram illustrating an example of a functional configuration of the support server 700 according to Embodiment 2. As illustrated, the support server 700 includes a transmitter 110, a receiver 120, a storage 130, and a controller 740. Note that the transmitter 110, receiver 120 and storage 130 have the same configurations as the transmitter 110, receiver 120 and storage 130 in the above-described server 100 of FIG. 3.

The controller 740 controls the entirety of the support server 700. The controller 740 includes, for example, a narrow-downer 741, a searcher 141, a selector 142, an evaluator 742, a presenter 743, an accepter 144, and a requester 145. Note that the searcher 141, selector 142, accepter 144, and requester 145 have the same configurations as the searcher 141, selector 142, accepter 144, and requester 145 in the above-described support server 100 (controller 140) of FIG. 3.

The narrow-downer 741 narrows down the deliverers. For example, the narrow-downer 741 narrows down the deliverers from the above-described deliverer management information 131 of FIG. 4, based on any one of a popularity of a deliverer, an advertisement fee for making a request to a deliverer, and a degree of correlation between the delivery content of a deliverer and the target commodity. For example, when narrow-down is executed based on the correlation between the delivery content of the deliverer and the target commodity, the narrow-downer 741 narrows down the deliverers with respect to which the degree of correlation between the principal delivery content 131c of the deliverer management information 131 and the target commodity is greater than a fixed value (excludes the deliverers with respect to which the degree of correlation is equal to or less than the fixed value).

Note that, like Embodiment 1, the searcher 141 searches, in association with each of the deliverers narrowed down by the narrow-downer 741, purchased commodities purchased on the electronic market by the viewers. In addition, like Embodiment 1, the selector 142 selects, in association with each of the deliverers narrowed down by the narrow-downer 741, a representative commodity from among the searched purchased commodities.

The evaluator 742 evaluates the influence of deliverers. For example, the evaluator 742 evaluates the influence of each of the deliverers narrowed down by the narrow-downer 741, by calculating a value that is obtained by multiplying the ratio of the number of purchasers (the average purchaser number 131e of FIG. 4) to the number of viewers (the average viewer number 131d of FIG. 4) by a predetermined coefficient K (for example, a unit price of a commodity). In short, the influence of the deliverer is evaluated by calculating (number of purchasers/number of viewers)×coefficient K.

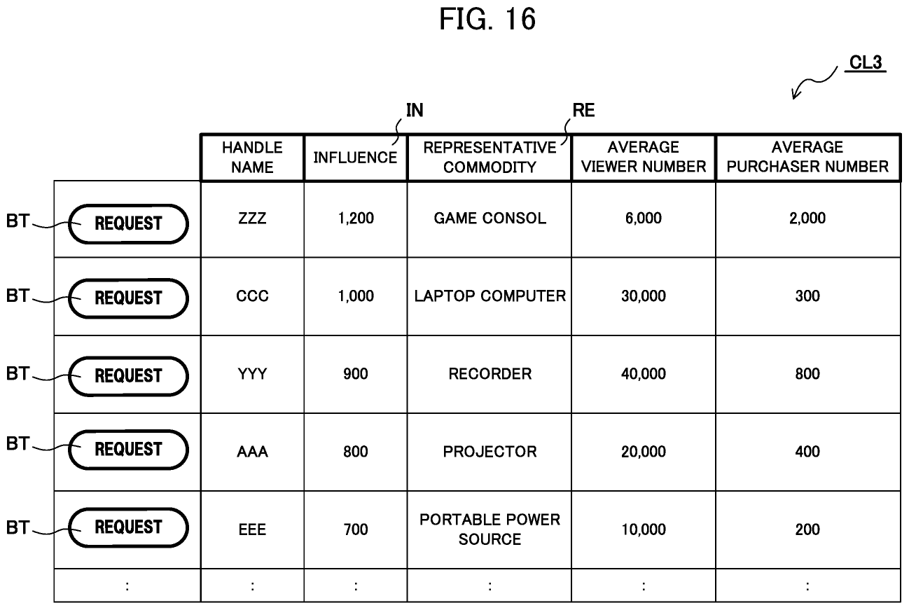

Then, the presenter 743 generates a candidate list in which deliverers sorted in accordance with the influence evaluated by the evaluator 742 are correlated with representative commodities, and presents the generated candidate list to the advertiser terminal 300. For example, the presenter 743 generates a candidate list CL3 as illustrated in FIG. 16, and presents the candidate list CL3 to the advertiser terminal 300. In the candidate list CL3, deliverers (handle names), who are sorted in the order from a greatest influence IN, are correlated with representative commodities RE selected by the selector 142. Note that when two representative commodities are selected by the selector 142 in association with deliverers, a candidate list, in which the deliverers who are sorted in the order from the greatest influence are correlated with the above-described first representative commodities RE1 and second representative commodities RE2 as illustrated in FIG. 9, may be presented to the advertiser terminal 300.

(Operation of Support Server 700)

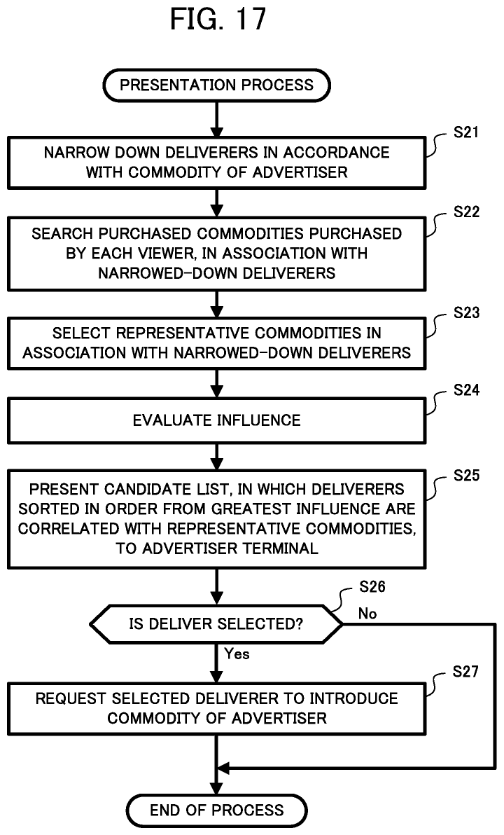

Hereinafter, an operation of the support server 700 is described with reference to FIG. 17. FIG. 17 is a flowchart for describing a presentation process according to Embodiment 2. The presentation process is executed by the support server 700, for example, when information of a target commodity that is a target of advertisement is sent from the advertiser terminal 300 to the support server 700.

To start with, the support server 700 narrows down the deliverers in accordance with the commodity of the advertiser (step S21). Specifically, the controller 740 (narrow-downer 741) narrows down the deliverers from the deliverer management information 131 of FIG. 4. For example, the controller 740 narrows down the deliverers from the deliverer management information 131, based on at least any one of a popularity of a deliverer, an advertisement fee for making a request to a deliverer, and a degree of correlation between the delivery content of a deliverer and the target commodity. For example, when narrow-down is executed based on the correlation between the delivery content of the deliverer and the target commodity, the controller 740 narrows down the deliverers with respect to which the degree of correlation between the principal delivery content 131c of the deliverer management information 131 and the target commodity is greater than a fixed value.

The support server 700 searches, in association with the deliverers narrowed down in the above-described step S21, purchased commodities purchased by each viewer (step S22).

The support server 700 selects representative commodities in association with the deliverers narrowed down in step S21 (step S23). Note that, in step S23, the support server 700 may select a plurality of representative commodities in association with the deliverer. For example, the controller 740 (selector 142) selects the first representative commodity from purchased commodities with a high degree of correlation with the target commodity, and selects the second representative commodity from purchased commodities with a low degree of correlation with the target commodity.

The support server 700 evaluates the influence of deliverers (step S24). For example, the controller 740 (evaluator 742) evaluates the influence of each of the deliverers narrowed down in step S21, by calculating a value that is obtained by multiplying the ratio of the number of purchasers to the number of viewers by the predetermined coefficient K.

The support server 700 generates a candidate list in which deliverers sorted in accordance with the influence evaluated in the above-described step S24 are correlated with representative commodities, and presents the candidate list to the advertiser terminal 300 (step S25). For example, the controller 740 (presenter 743) generates the candidate list CL3 as illustrated in FIG. 16, and presents the candidate list CL3 to the advertiser terminal 300. In the candidate list CL3, deliverers (handle names), who are sorted in the order from the greatest influence IN, are correlated with representative commodities RE selected by the selector 142. Note that, in step S23, when two representative commodities are selected in association with deliverers, the controller 740 may present to the advertiser terminal 300 a candidate list in which the deliverers who are sorted in the order from the greatest influence are correlated with the above-described first representative commodities RE1 and second representative commodities RE2 as illustrated in FIG. 9.

The support server 700 determines whether the deliverer is selected (step S26). For example, the controller 740 determines whether any one of the select buttons BT is pressed in the advertiser terminal 300 to which the candidate list CL3 illustrated in FIG. 16 is presented. Note that if any one of the select buttons BT in the candidate list CL3 is pressed by the advertiser, the identification information (deliverer ID or the like) of the deliverer corresponding to the pressed select button BT is returned to the support server 700 from the advertiser terminal 300.

If the support server 700 determines that the deliverer is selected (step S26; Yes), the support server 700 requests the selected deliverer to introduce the commodity of the advertiser (step S27). In other words, the controller 740 (requester 145) requests the deliverer of the identification information, which is returned from the advertiser terminal 300, to introduce the target commodity.

On the other hand, when no selection of the deliverer is determined (step S26; No), the support server 700 ends the presentation process. Note that the determination of no selection of the deliverer is made, for example, when the candidate list CL3 is closed without pressing of the select button BT.

By this presentation process, the candidate list CL3 as illustrated in FIG. 16 is presented to the advertiser terminal 300. In the candidate list CL3, the deliverers are narrowed down and the delivers sorted in the order from the greatest influence are correlated with the representative commodities RE. Thus, it becomes easier to determine a deliverer whose viewers match with the purchaser base for the target commodity of the advertiser, and the advertiser can select an appropriate deliverer. Specifically, since actual commodity examples purchased by viewers, together with the influence, are presented, the advertiser can select the deliverer who is to be requested, with agreement in an easy-to-understand manner. As a result, a support can be provided for the advertiser to make a request for advertisement to a more appropriate deliverer.

### Other Embodiments

In Embodiments 1 and 2 described above, the case was described in which the support server 100, 700 presents the candidate list to the advertiser terminal 300. However, the delivery server 200 may be configured to present the candidate list to the advertiser terminal 300, by adding to the controller 230 of the delivery server 200 the searcher 141, selector 142, presenter 143, 743, narrow-downer 741, evaluator 742, and the like in the controller 140, 740 of the support server 100, 700. In this case, too, a support can be provided for the advertiser to make a request for advertisement to a more appropriate deliverer.

In Embodiments 1 and 2 described above, the delivery system 1, 2, which is suitable when an advertiser makes a request for advertisement (introduction) of a commodity to a deliverer of motion video, was described. However, the deliverer is an example of a sender, and the present disclosure can similarly be applied to a case of making a request for advertisement to a sender that sends information through other contents (for example, a blog, an SNS, and the like). In this case, a representative commodity, which is selected from purchased commodities purchased by users that received information through other contents sent by the deliverer (for example, users that accessed posts or the like of a blog, an SNS or the like), is presented to the advertiser. Specifically, a support can be provided for the advertiser to make a request for advertisement to a more appropriate sender, not only in “advertisement” in which the deliverer introduces the target commodity by motion video, as described above, but also in “advertisement” in which a sender who sends information such as a blog introduces the target commodity by writing or photographs.

In Embodiments 1 and 2 described above, the program executed by the support server 100, 700, or the like can be distributed by being stored in non-transitory computer-readable media such as a compact disc read-only memory (CD-ROM), a digital versatile disc (DVD), a magneto-optical disk (MO), a USB memory, a memory card, and the like. By installing the program in a specific or general computer, the computer can be caused to function as the support server 100, 700 in Embodiment 1, 2 described above.

Besides, the above-described program may be stored in a disk device included in a server device on a communication network such as the Internet, and, for example, may be superimposed on a carrier wave and downloaded in a computer. In addition, also by starting and executing the program while transferring the program via the communication network, the above-described process can be achieved. Moreover, also by causing the server device to execute the entirety or a part of the program and by causing the computer to execute the program while transmitting and receiving information relating to the processing of the program via the communication network, the above-described process can be achieved.

Note that when the above-described functions are shared and implemented by an operating system (OS) or implemented by the cooperation between the OS and an application, only the part other than the OS may be stored in the above-described media and distributed, or may be downloaded in the computer.
[1] A server device including a processor to execute:
search of a purchased commodity purchased on an electronic market by a user who received information sent from a sender, in association with each of a plurality of the senders to which a request for advertisement of a target commodity is capable of being made;
selection of a representative commodity from the searched purchased commodities in association with each of the senders; and
presentation of a candidate list, in which the selected representative commodity is correlated with each of the senders, to an advertiser terminal.
[2] The server device according to [1], wherein
the sender is a deliverer who delivers motion video, and
the user is a viewer who viewed the motion video delivered from the deliverer.
[3] The server device according to [1] or [2], wherein the selection of the representative commodity is executed based on at least any one of a time of purchase of the purchased commodities, a total number of the purchased commodities, and a degree of correlation between the purchased commodities and the target commodity.
[4] The server device according to [1] or [2], wherein the selected representative commodities include a first representative commodity selected from the purchased commodities with a high degree of correlation with the target commodity, and a second representative commodity selected from the purchased commodities with a low degree of correlation with the target commodity.
[5] The server device according to any one of [1] to [4], wherein the processer further executes narrow-down of the senders, the narrow-down being based on at least any one of a popularity of the sender, an advertisement fee for making a request to the sender, and a degree of correlation between a sending content of the sender and the target commodity.
[6] The server device according to any one of [1] to [5], wherein
the processer further executes evaluation of an influence of the sender, and
in the presented candidate list, the senders sorted in accordance with the evaluated influence are correlated with the representative commodities.
[7] The server device according to any one of [1] to [6], wherein the processor further executes:
acceptance of a sender to whom a request is made, the sender being selected in the advertiser terminal to which the candidate list is presented; and
making a request for the advertisement of the target commodity to the accepted sender.
[8] A presentation method for causing a computer to execute:
search of a purchased commodity purchased on an electronic market by a user who received information sent from a sender, in association with each of a plurality of the senders to which a request for advertisement of a target commodity is capable of being made;
selection of a representative commodity from the searched purchased commodities in association with each of the senders; and
presentation of a candidate list, in which the selected representative commodity is correlated with each of the senders, to an advertiser terminal.
[9] Non-transitory computer readable media recording a program for causing a computer to execute:
search of a purchased commodity purchased on an electronic market by a user who received information sent from a sender, in association with each of a plurality of the senders to which a request for advertisement of a target commodity is capable of being made;
selection of a representative commodity from the searched purchased commodities in association with each of the senders; and
presentation of a candidate list, in which the selected representative commodity is correlated with each of the senders, to an advertiser terminal.

### INDUSTRIAL APPLICABILITY

The present disclosure can preferably be adopted in a server device, a presentation method, and non-transitory computer readable media, which can support an advertiser in making a request for advertisement to a more appropriate sender.

### REFERENCE SIGNS LIST

1, 2 Delivery system
100, 700 Support server
110 Transmitter
120 Receiver
130 Storage
131 Deliverer management information
132 Viewer management information
133 Purchase history information
140, 740 Controller
141 Searcher
142 Selector
143, 743 Presenter
144 Accepter
145 Requester
741 Narrow-downer
742 Evaluator
200 Delivery server
210 Transmitter-receiver
220 Storage
230 Controller
231 Manager
232 Delivery controller
300 Advertiser terminal
310 Transmitter-receiver
320 Operation accepter
330 Storage
340 Controller
350 Display
400 Deliverer terminal
410 Photographer
420 Transmitter-receiver
430 Operation accepter
440 Storage
450 Controller
451 Compositor
452 Distributor
460 Display
500 Viewer terminal
600 Information processing apparatus
601 CPU
602 ROM
603 RAM
604 NIC
605 Image processor
606 Audio processor
607 Auxiliary storage
608 Interface
609 Photography unit
610 Operation unit
611 Display unit
900 Internet

1. A server device, comprising:
a processor to execute:
search of a purchased commodity purchased on an electronic market by a user who received information sent from a sender, in association with each of a plurality of the senders to which a request for advertisement of a target commodity is capable of being made;
selection of a representative commodity from the searched purchased commodities in association with each of the senders; and
presentation of a candidate list, in which the selected representative commodity is correlated with each of the senders, to an advertiser terminal.

2. The server device according to claim 1, wherein
the sender is a deliverer who delivers motion video, and
the user is a viewer who viewed the motion video delivered from the deliverer.

3. The server device according to claim 1, wherein the selection of the representative commodity is executed based on at least any one of a time of purchase of the purchased commodities, a total number of the purchased commodities, and a degree of correlation between the purchased commodities and the target commodity.

4. The server device according to claim 1, wherein the selected representative commodities include a first representative commodity selected from the purchased commodities with a high degree of correlation with the target commodity, and a second representative commodity selected from the purchased commodities with a low degree of correlation with the target commodity.

5. The server device according to claim 1, wherein the processer further executes narrow-down of the senders, the narrow-down being based on at least any one of a popularity of the sender, an advertisement fee for making a request to the sender, and a degree of correlation between a sending content of the sender and the target commodity.

6. The server device according to claim 1, wherein
the processer further executes evaluation of an influence of the sender, and
in the presented candidate list, the senders sorted in accordance with the evaluated influence are correlated with the representative commodities.

7. The server device according to claim 1, wherein the processor further executes:
acceptance of a sender to whom a request is made, the sender being selected in the advertiser terminal to which the candidate list is presented; and
making a request for the advertisement of the target commodity to the accepted sender.

8. A presentation method for causing a computer to execute:
searching of a purchased commodity purchased on an electronic market by a user who received information sent from a sender, in association with each of a plurality of the senders to which a request for advertisement of a target commodity is capable of being made;
selecting of a representative commodity from the searched purchased commodities in association with each of the senders; and
presenting of a candidate list, in which the selected representative commodity is correlated with each of the senders, to an advertiser terminal.

9. Non-transitory computer readable media recording a program for causing a computer to execute:
search of a purchased commodity purchased on an electronic market by a user who received information sent from a sender, in association with each of a plurality of the senders to which a request for advertisement of a target commodity is capable of being made;
selection of a representative commodity from the searched purchased commodities in association with each of the senders; and
presentation of a candidate list, in which the selected representative commodity is correlated with each of the senders, to an advertiser terminal.
